(19) United States
(12) Patent Application Publication
(10) Pub. No.: US 2012/0160107 A1
(43) Pub. Date: Jun. 28, 2012

(54) DRIPPING DEVICE

(76) Inventor: Jung-Jung TIEN, Taipei City (TW)

(21) Appl. No.: 13/413,623

(22) Filed: Mar. 6, 2012

Related U.S. Application Data
(63) Continuation-in-part of application No. 12/425,409, filed on Apr. 17, 2009.

(51) Int. Cl. A47J 31/06

(52) U.S. Cl. 99/298

(57) ABSTRACT

The dripping device contains a body member, a blocking member at the bottom of the body member with a through channel to allow the brewed drink to flow through, a filter member, and an engaging member vertically moveable to allow/stop the flowing of the brewed drink. The major characteristics of the present invention are as follows. The inner wall of the body member is configured with a number of protruding locking elements for locking the filter member in its place. The engaging member has a vertical column with an upper cylinder on which a valve element is mounted. The valve element is made of a flexible material and is for blocking the through channel of the blocking member. The dripping device has advantages such as enhanced water-tightness, easy assembly, lower cost, and the problem of the conventional spherical blocking element is avoided.

### CROSS-REFERENCE TO RELATED APPLICATION

This is a continuation-in-part of the co-pending patent application Ser. No. 12/425,409, owned by the same applicant.

### (a) TECHNICAL FIELD OF THE INVENTION

The present invention is generally related to dripping devices for brewing coffee or tea or other drinks, and more particular to a dripping device with enhanced water-tightness, easy assembly, and lower cost.

### (b) DESCRIPTION OF THE PRIOR ART

A conventional dripping device has the following disadvantages.

Firstly, the mesh for separating coffee grounds and tea leaves and for filtering impurities are usually stuck on the inner wall of the dripping device. After repeated installation and removal, the mesh cannot be securely positioned.

Secondly, the conventional dripping device usually relies on a spherical blocking element's blocking or opening an outlet of the dripping device to control the flowing of the brewed drink. However, the blocking element is light and could easily roll away from the outlet. The outlet is therefore not securely blocked. On the other hand, the roundness of the blocking element has to be precise to achieve effective blocking, but perfect roundness is difficult to achieve and leaking is inevitable, causing various hygiene and cleaning problems.

Thirdly, the cost for making a metallic blocking element with a high degree of roundness is significant.

Fourthly, the rolling blocking element is often and easily misplaced.

### SUMMARY OF THE INVENTION

Therefore a novel dripping device is provided here. The dripping device contains a body member, a blocking member, a filter member, and an engaging member. The body member has a through hole at the bottom and a flange is provided at the bottom with a number of foot rests around its circumference. A cover is hinged to the body member. The cover has a guiding plate extended vertically downward. The blocking member is made of a flexible material and has a through channel. The filter and engaging members are configured inside the body member, and the engaging member is vertically moveable relative to the body member. The engaging member has a vertical column and a number of openings to allow the brewed drink to flow through. The major characteristics of the present invention are as follows. The inner wall of the body member is configured with a number of protruding locking elements for locking the filter member in its place. The vertical column is plugged into the through channel of the blocking member, and has an upper cylinder with a step around it. Adjacent to a top end of the upper cylinder, a ring groove is configured. A valve element is mounted on the top end of the vertical column. The valve element is made of a flexible material and has a vertical through channel with a top opening. Inside the through channel of the valve element, a ring rib matching the ring groove on the vertical column is configured. As such, when the upper cylinder is plugged into the through channel of the valve element, the ring rib is embedded into the ring groove and the bottom of the valve element rests securely on the step. The valve element is for blocking the through channel of the blocking member and the lower half of the valve element is configured with a cone-like circumferential surface.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a dripping device according to a first embodiment of the present invention.

FIG. 2 is a perspective break-down diagram showing the various components of the dripping device of FIG. 1.

FIG. 3 is a partially enlarged diagram showing how the filter member is securely positioned inside the body member of the dripping device of FIG. 1.

FIG. 4 is a perspective diagram showing the valve element and the other elements of the engaging member of the dripping device of FIG. 1.

FIG. 5 is a sectional diagram showing the valve element and the vertical column of the dripping device of FIG. 1.

FIG. 6 is schematic diagram showing how a drink is held inside the body member of the dripping device of FIG. 1.

FIG. 7 is schematic diagram showing how a drink is released from the body member of the dripping device of FIG. 1.

FIG. 8 is a perspective diagram showing a dripping device according to a second embodiment of the present invention.

FIG. 8A is a partially enlarged diagram showing how the filter member is positioned and locked by the locking elements of the dripping device of FIG. 8.

FIG. 9 is a perspective diagram showing a dripping device according to a third embodiment of the present invention.

FIG. 9A is a partially enlarged diagram showing how the filter member is positioned and locked by the locking element of the dripping device of FIG. 9.

FIG. 10 is a perspective diagram showing an alternative filter member of the dripping device of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

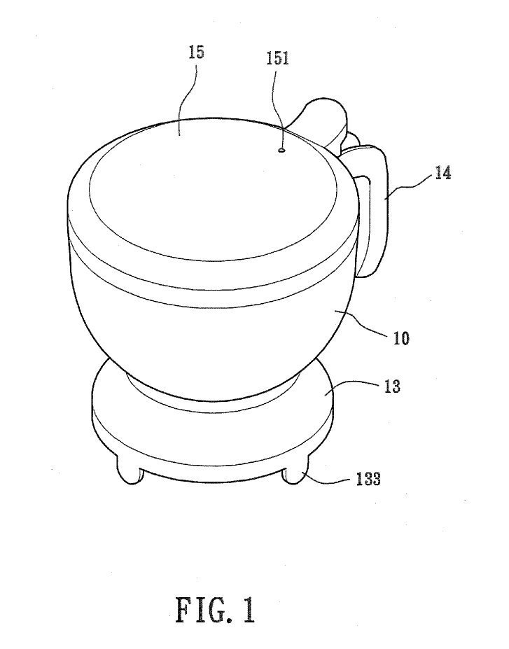

As shown in FIGS. 1, 2, and 6, a dripping device according to a first embodiment of the present invention contains a body member 10, a blocking member 20, a filter member 30, and an engaging member 40.

The body member 10 has an open top and is hollow so as to hold coffee grounds or tea leaves or other objects for making drinks. A through hole 11 is provided at the bottom of the body member 10 and a ring wall 111 surrounds the through hole 11. The inner wall of the body member 10 is configured with a number of locking elements 12 which are curved protrusions. A flange 13 is provided at the bottom surrounding the body member 10. Inside the flange 13, there is a co-centric ring wall 131 and, along the ring wall 131, there are a number of equal-spacing vertical slots 132. The flange 13 has a larger diameter than the engaging member 40. The flange 13 has a number of foot rests 133 around its circumference for steadily supporting the dripping device. To a side of the body member 10, a handle 14 for easy grasping is provided. A cover 15 is hinged to the handle 14. The cover 15 has a ventilation hole 151 and a guiding plate 152 is extended vertically downward from the cover 15 toward the top opening of the body member 10.

The blocking member 20 is made of a flexible material such as food-grade plastic. The blocking member 20 has a ring groove 21 matching the ring wall 111 so that the blocking member 20 can be fastened on the ring wall 111 and as such joined to the through hole 11. The blocking member 20 has a through channel 22 and a ring groove 23 configured around a top opening of the through channel 22, thereby forming a ring wall 24 around the top opening of the through channel 22. The ring wall 24 will be deformed under pressure.

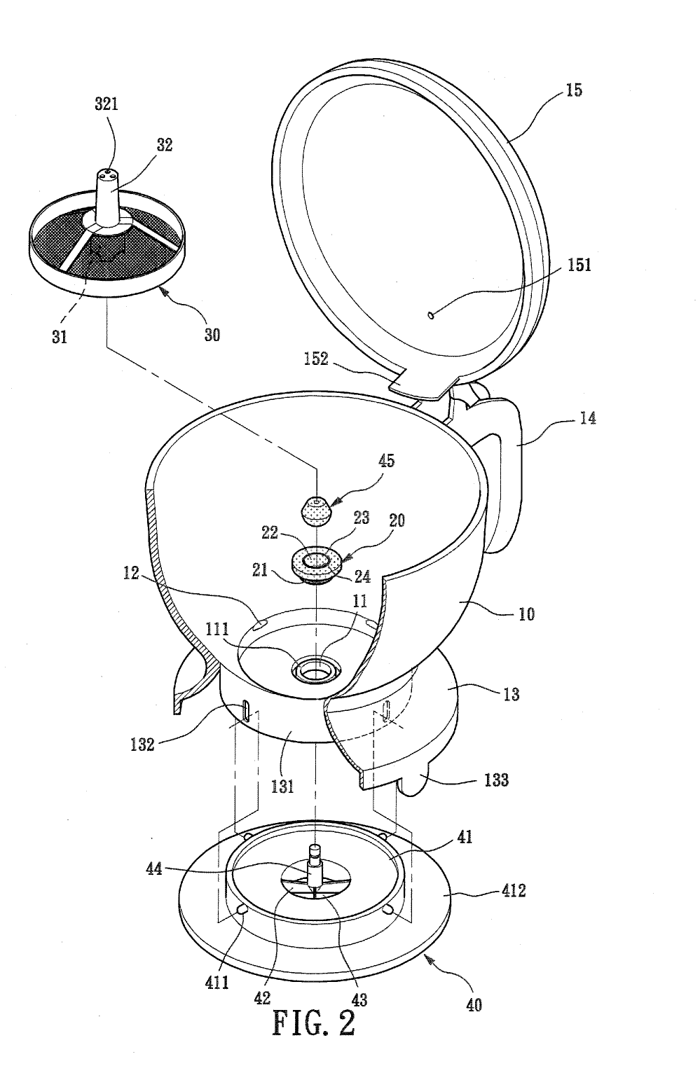

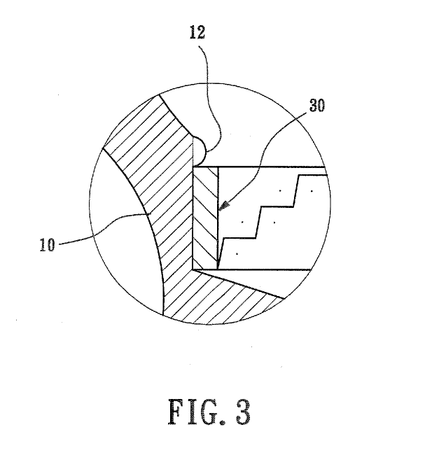

The filter member 30 is for filtering impurities. As shown in FIGS. 2, 3, and 6, at the center of the filter member 30, an air pipe 32 and a positioning tube 31 are aligned and extended vertically above and below the filter member 30, respectively. The air pipe 32 has a number of through channels, each with a top opening 321, and a bottom end connected to the positioning tube 32. The filter member 30 is also made of a flexible plastic material. When it is installed in the body member 10, a slight force will push the filter member 30 through the locking members 12 and the filter member 30 is securely locked beneath the locking members 12. As such the filter member 30 can be easily and reliably installed and removed.

As shown in FIGS. 2, 3, and 6, the engaging member 40 has a seat element 41 and the seat element 41 has a number of rib plates 42 by which a number of openings 43 are formed to allow the brewed drink to flow through. At an intersection of the rib plates 42, a vertical column 44 is configured. Along the circumference of the seat element 41, a number of radially extending protrusions 411 are configured. A flange 412 is extended laterally beneath the seat element 41. As the engaging member 40 is made of a plastic material, the protrusions 411 can be embedded into the slots 132 so that the engaging member 40 is joined to body member 10. The engaging member 40 can move up and down under the body member 10 as the protrusions 411 are confined in the slots 132. The diameter of the engaging member 40 is smaller than that of the flange 13 so that the engaging member 40 is concealed in the flange 13.

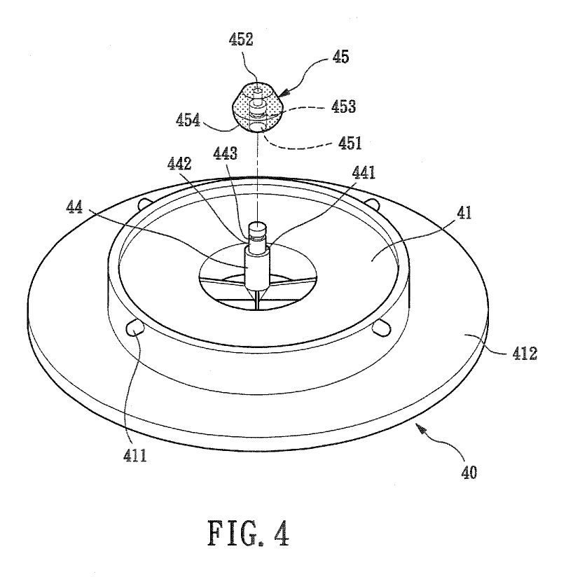

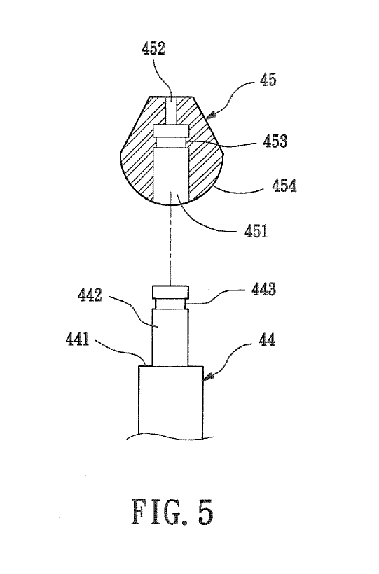

As shown in FIGS. 4, 5, and 6, the vertical column 44 is plugged into the through channel 22 of the blocking member 20. The vertical column 44 contains a lower cylinder with a larger diameter and an upper cylinder 442 with a smaller diameter, thereby forming a step 441 around the upper cylinder 442. Adjacent to a top end of the upper cylinder 442, a ring groove 443 is configured. A valve element 45 is mounted on the top end of the vertical column 44. The valve element 45 is made of a flexible material such as food-grade plastic and the manufacturing cost is rather low. The valve element 45 has a vertical through channel 451 with a top opening 452. Inside the through channel 451, a ring rib 453 matching the ring groove 453 is configured. As such, when the upper cylinder 442 is plugged into the through channel 451, the ring rib 453 is embedded into the ring groove 443 and the bottom of the valve element 45 rests securely on the step 441. The top opening 452 allows air in the through channel 451 to escape when the valve element 45 is mounted on the vertical column 44. Therefore, in contrast to the conventional spherical blocking element, the valve element 45 and the vertical column 44 are not only easy to manufacture but also convenient to install, remove, and clean. The valve element 45 is for blocking the through channel 22 of the blocking member 20. To achieve that, the lower half of the valve element 45 is configured with a cone-like circumferential surface 454.

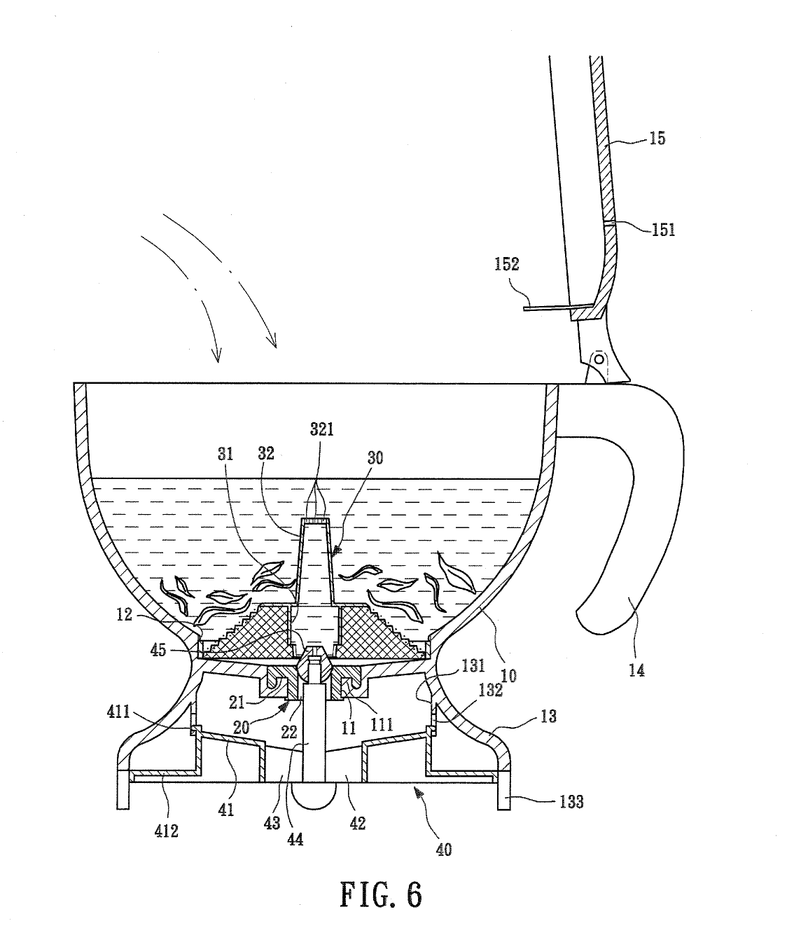

As shown in FIG. 6, when coffee grounds and tea leaves are brewed in the body member 10, the engaging member 40 moves downward due to gravity. The valve element 45 on the vertical column 44 descends as well. The valve element 45 blocks the through channel 22 of the blocking member 20 and the brewed drink is securely held in the body member 10 for the coffee grounds or tea leaves to be fully processed.

When the valve element 45 blocks the through channel 22, it is under both the pressure of the brewed drink and the weight of the engaging member 40. The valve element 45 as such securely and tightly blocks the through channel 22. In addition, as the valve element 45 has its conic surface 454 interfacing with and thereby deforming the ring wall 24 of the through channel 22. The ring wall 24 and the conic surface 454 as such are tightly and completely attached with each other. The through channel 22 is thereby completely shut, achieving a very high degree of water-tightness. The manufacture of the valve element 45 is inexpensive as perfect roundness is not required.

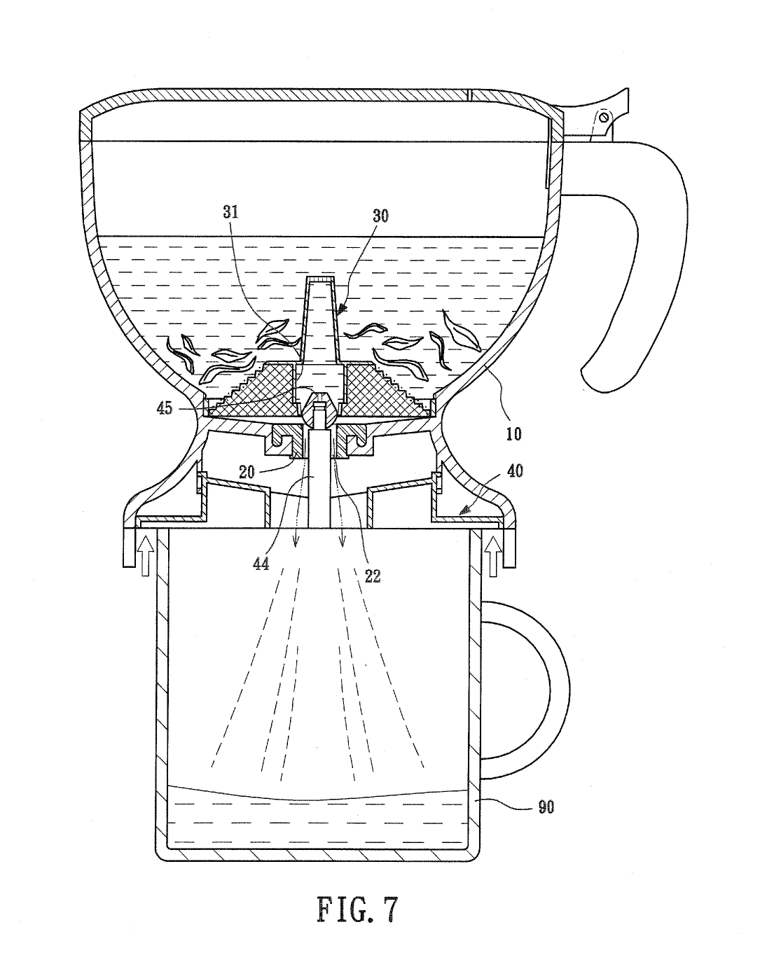

As shown in FIG. 7, to release the brewed drink, the dripping device is placed on a top opening of a container 90. Due to the support of the container 90, the engaging member 40 does not move downward along with the body member 10. The valve element 45 as such is separated from the through channel 22 of the blocking member 20. The brewed drink than can flow into the container 90 through the through channel 22 and the engaging member 40.

When the valve element 45 rests upon the through channel 22, a portion of the valve element 45 is inside the positioning tube 31 of the filter member 30. When the valve element 45 is separated from the through channel 22, more of it is inside the positioning tube 31. In other words, the up and down movement of the valve element 45 is confined in the positioning tube 31 and will not get stray. The blocking of the through channel 22 by the valve element 45 is reliable.

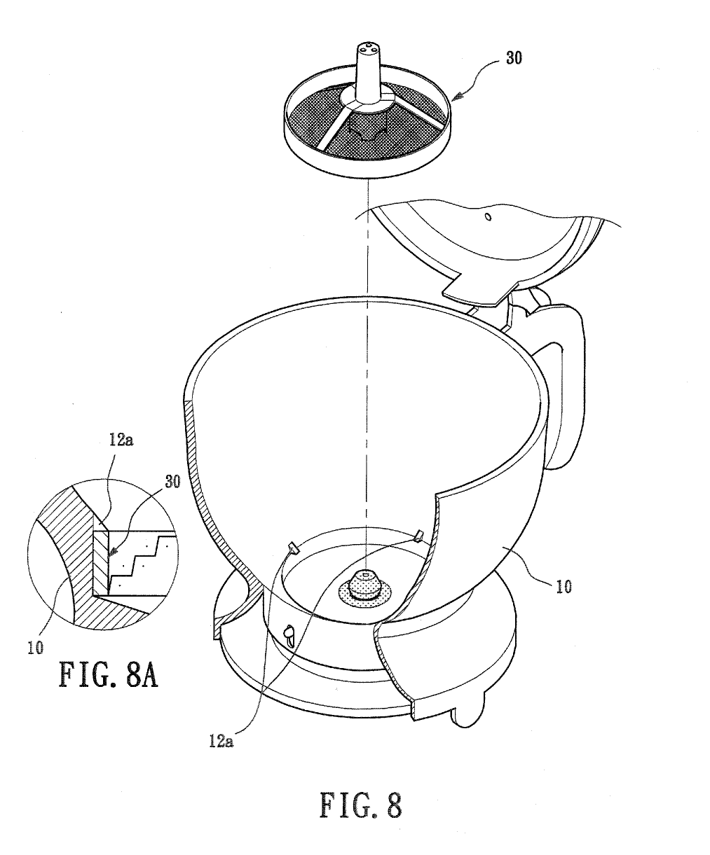

As shown in FIG. 8, in a second embodiment of the present invention, the locking elements 12a are protrusions with slant top surfaces so that the filter member 30 could slide down the slant surfaces and then reliably positions itself beneath the locking elements 12a.

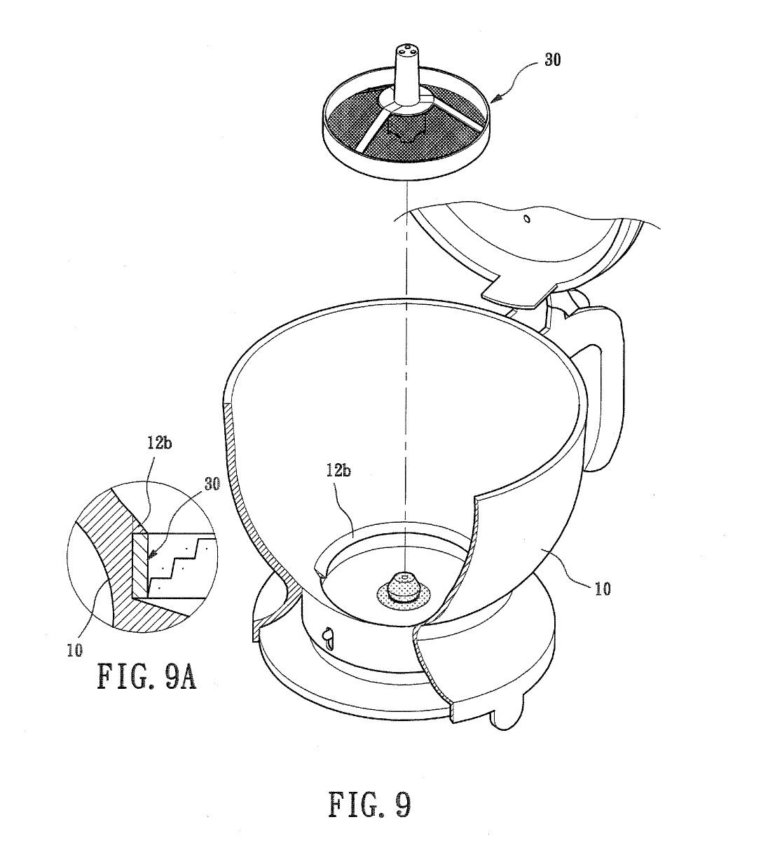

As shown in FIG. 9, in a third embodiment of the present invention, the locking element 12b is a ring protrusion with a slant top surface so that the filter member 30 could slid down the slant surface and then reliably positions itself beneath the locking element 12b.

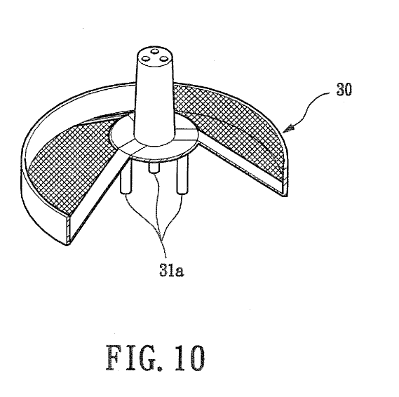

As shown in FIG. 10, in an alternative embodiment of the filter member 30, there could be more than one positioning tubes 31a extending vertically downward in parallel.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A dripping device for making brewed drink, comprising:
a body member where the body member has a through hole at the bottom, a flange is provided at the bottom with a number of foot rests, a cover is hinged to the body member, and the cover has a guiding plate extended vertically downward;
a blocking member made of a flexible material with a through channel where the blocking member is configured on the through hole of the body member;
a filter member configured inside the body member;
an engaging member inside and vertically moveable relative to the body member where the engaging member has a valve element, a vertical column, and a plurality of openings to allow the brewed drink to flow through;
wherein the inner wall of the body member is configured with at least a locking element for locking the filter member; the vertical column is plugged into the through channel of the blocking member, and has an upper cylinder with a step around the upper cylinder; a ring groove is configured adjacent to a top end of the upper cylinder; the valve element is mounted on the top end of the vertical column; the valve element is made of a flexible material and has a vertical through channel with a top opening; a ring rib matching the ring groove on the vertical column is configured inside the through channel of the valve element so that, when the upper cylinder is plugged into the through channel of the valve element, the ring rib is embedded into the ring groove and the bottom of the valve element rests securely on the step; the valve element is for blocking the through channel of the blocking member and the lower half of the valve element is configured with a cone-like circumferential surface.

2. The dripping device according to claim 1, wherein a ring groove configured around a top opening of the through channel of the blocking member, thereby forming a deformable ring wall.

3. The dripping device according to claim 1, wherein the locking element is a curved protrusion.

4. The dripping device according to claim 1, wherein the locking element is a protrusion with slant top surface.

5. The dripping device according to claim 1, wherein the locking element is a ring protrusion with a slant top surface.

6. The dripping device according to claim 1, wherein at least a positioning tube is configured beneath the filter member and extended vertically downward in parallel; and at least a portion of the valve element is inside a positioning tube.
